(19) United States
(12) Patent Application Publication
(10) Pub. No.: US 2026/0052082 A1
(43) Pub. Date: Feb. 19, 2026

(54) EXTRACTING INSIGHTS FROM REAL-TIME INTERNET ROUTING DATA

(71) Applicant: Cisco Technology, Inc., San Jose, CA (US)

(72) Inventors: Javier Cruz Mota, Lussy-sur-Morges (CH); Federico Lovison, Fontanelle (IT); Carlo Zapponi, Milano (IT); Sukrit Dasgupta, Norfolk, MA (US)

(73) Assignee: Cisco Technology, Inc., San Jose, CA (US)

(21) Appl. No.: 18/807,212

(22) Filed: Aug. 16, 2024

(51) Int. Cl. H04L 43/045; H04L 43/0817; H04L 43/10; H04L 45/00

(52) U.S. Cl. CPC H04L 43/045; H04L 43/0817; H04L 43/10; H04L 45/22

(57) ABSTRACT

In one implementation, a device generates a routing graph using path trace data, wherein nodes of the routing graph represent different entities in one or more computer networks. The device computes importance metrics for the nodes in the routing graph based on their traffic loads. The device generates an insight regarding the one or more computer networks based on the importance metrics for the nodes. The device provides the insight to a user interface for presentation to a user.

### TECHNICAL FIELD

The present disclosure relates generally to computer systems, and, more particularly, to extracting insights from real-time Internet routing data.

### BACKGROUND

Many clients, applications, and services are now distributed throughout the globe thanks to the Internet. While the Internet is often thought of as a monolithic network, in reality, it is composed of many interconnected, smaller networks. Accordingly, a client and an application or service may exchange traffic that traverses any number of these networks. Typically, routing decisions to select the traffic path(s) are governed by the routing protocols used both within these networks, as well as between these networks.

The size and the complexity of the Internet has presented challenges with respect to assessing its traffic patterns in real-time. Indeed, there are often multiple paths that are valid between any two points on the Internet. In addition, both traffic patterns and routing decisions are dynamic and decentralized. Further, many network operators control how traffic traverses their networks and do not provide any mechanisms affording visibility into the routing decisions. Many times, policies also prevent measurement probes from traversing these networks adding to this opacity.

### BRIEF DESCRIPTION OF THE DRA WINGS

The implementations herein may be better understood by referring to the following description in conjunction with the accompanying drawings in which like reference numerals indicate identically or functionally similar elements, of which:

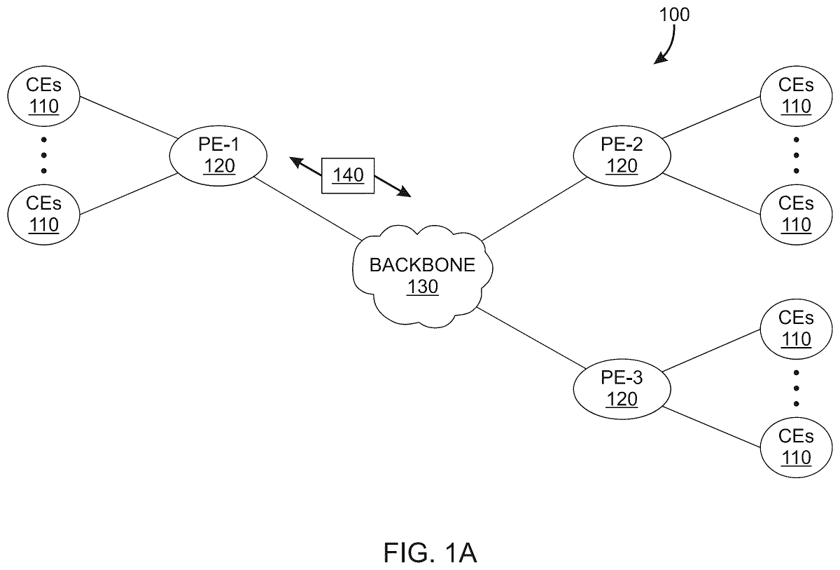

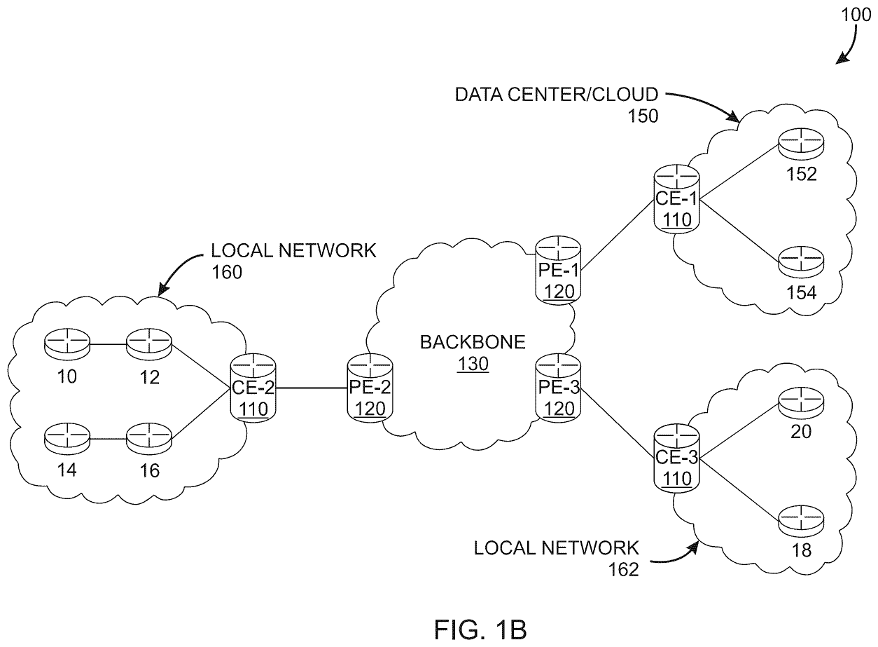

FIGS. 1A-1B illustrate an example communication network;

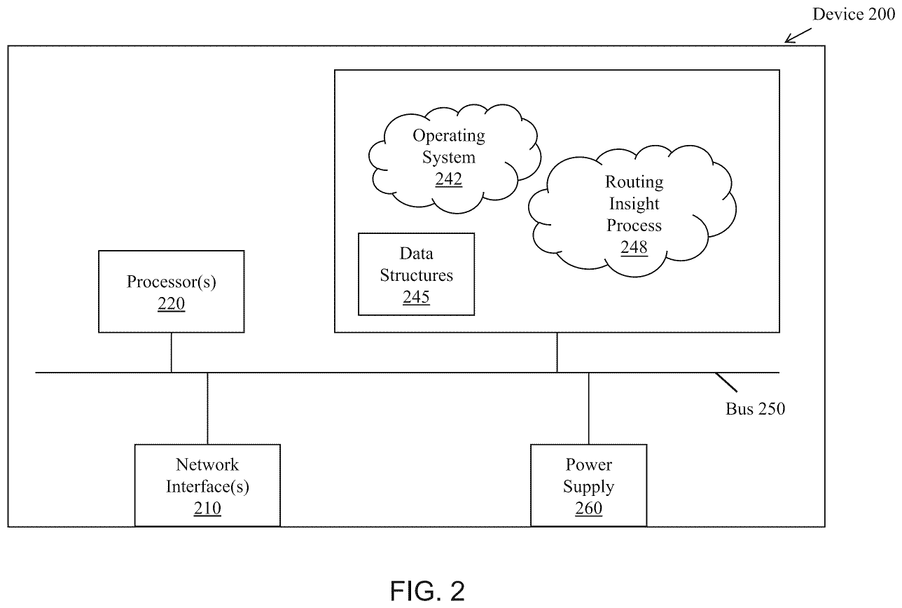

FIG. 2 illustrates an example network device/node;

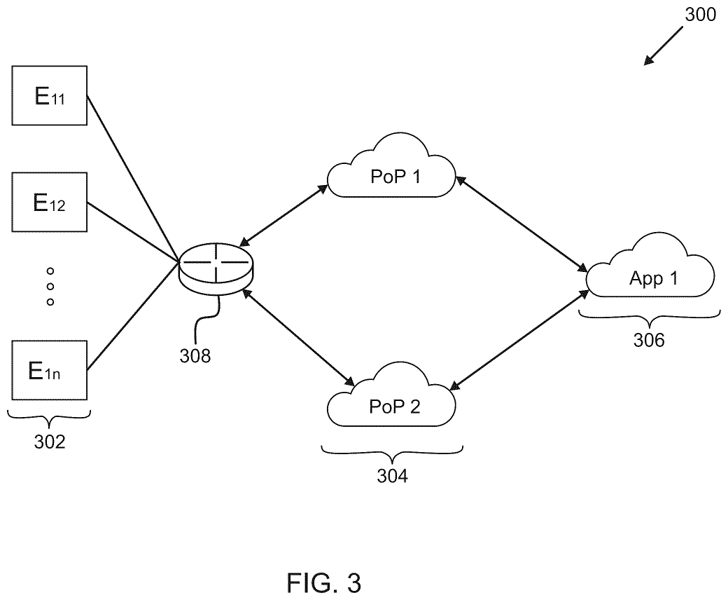

FIG. 3 illustrates an example of an edge router connecting to a cloud-hosted application via multiple points-of-presence (PoPs);

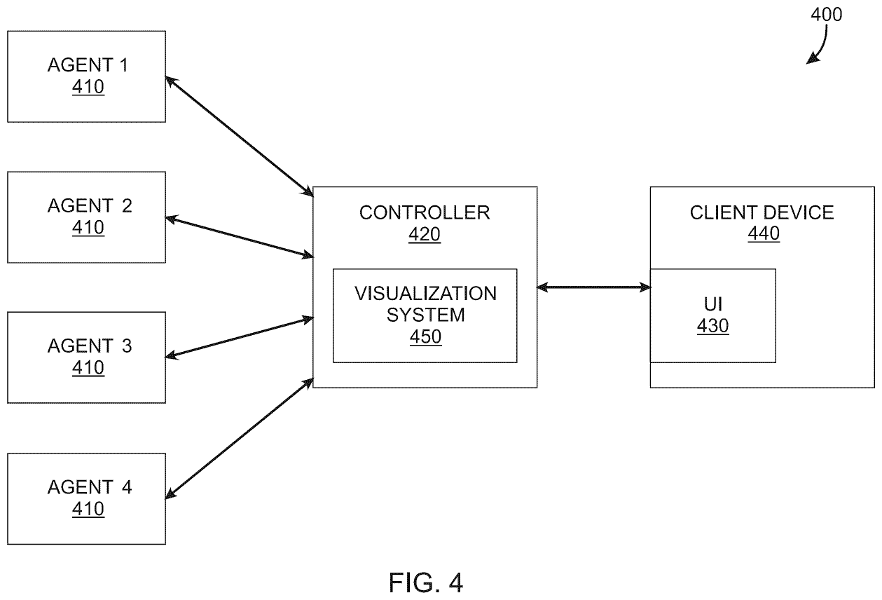

FIG. 4 illustrates an example architecture for a network observability intelligence platform;

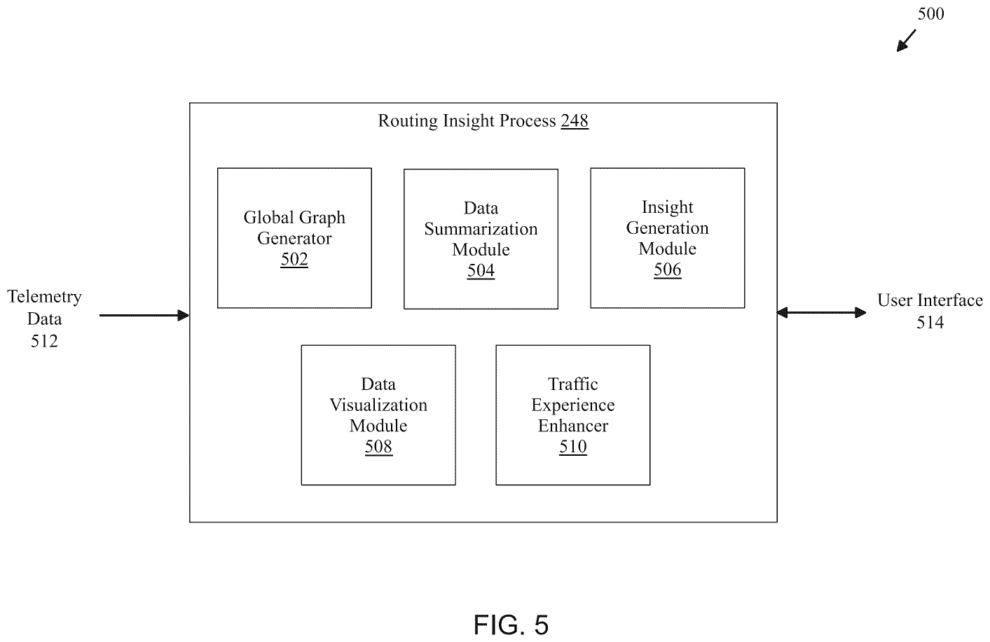

FIG. 5 illustrates an example architecture for extracting insights from real-time Internet routing data;

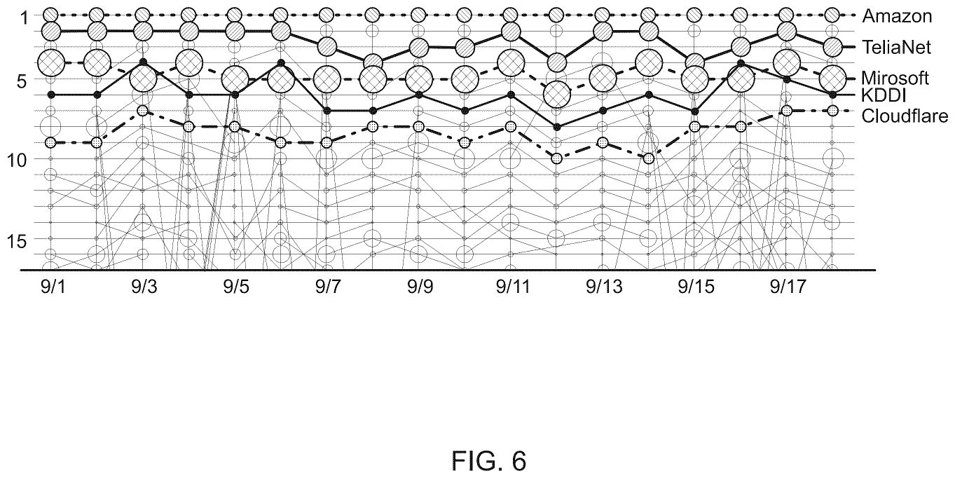

FIG. 6 illustrates an example plot of importance metrics for different autonomous systems over time;

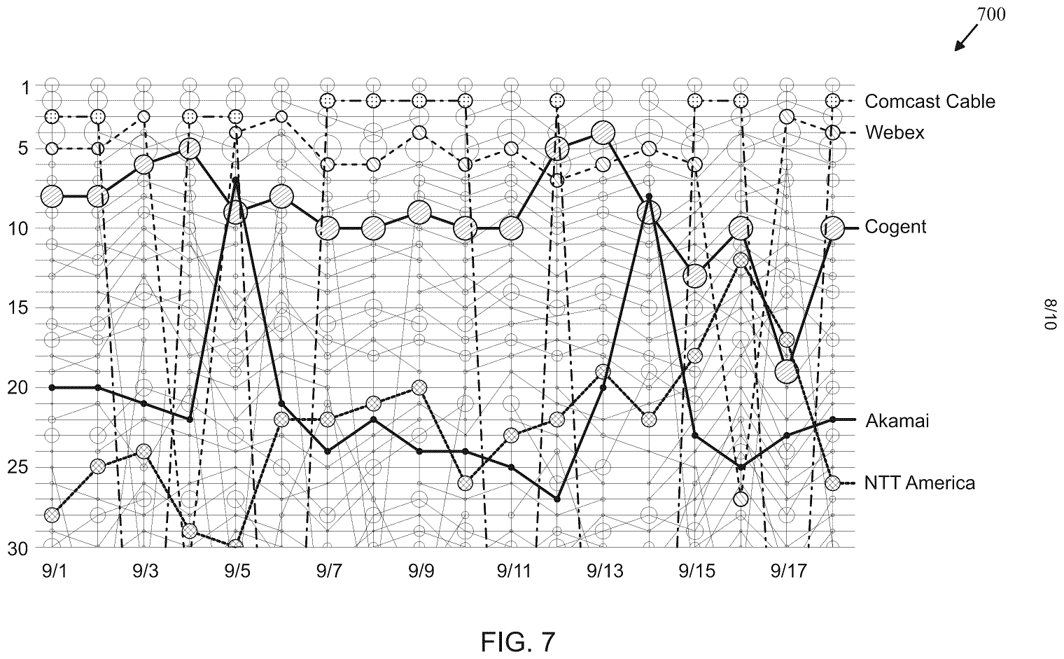

FIG. 7 illustrates an example plot showing unstable importance metrics for different autonomous systems over time;

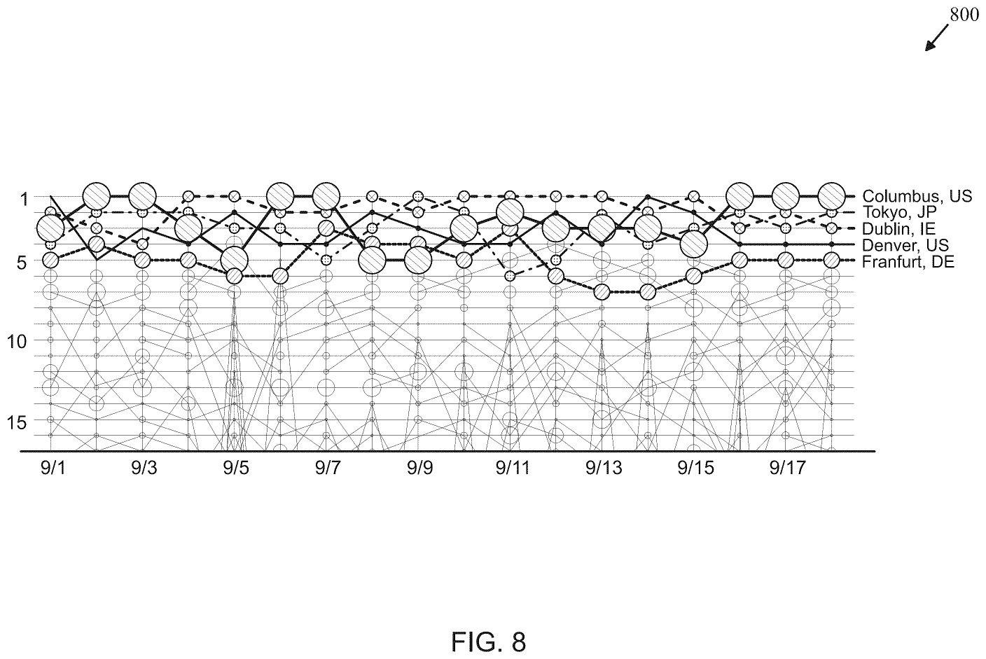

FIG. 8 illustrates an example plot of importance metrics for different PoPs over time; and

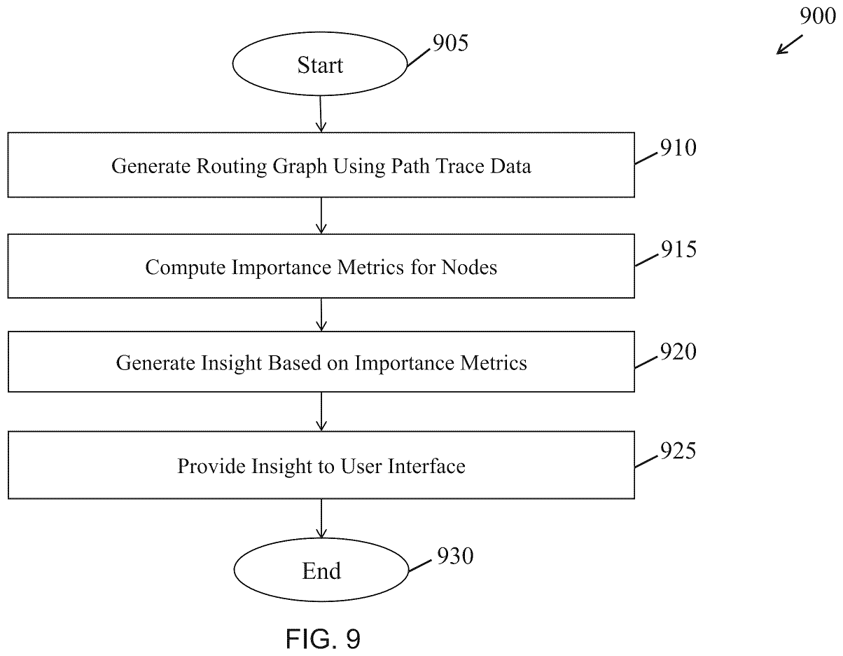

FIG. 9 illustrates an example of a simplified procedure for extracting insights from real-time Internet routing data.

### DESCRIPTION OF EXAMPLE EMBODIMENTS

### Overview

According to one or more implementations of the disclosure, a device generates a routing graph using path trace data, wherein nodes of the routing graph represent different entities in one or more computer networks. The device computes importance metrics for the nodes in the routing graph based on their traffic loads. The device generates an insight regarding the one or more computer networks based on the importance metrics for the nodes. The device provides the insight to a user interface for presentation to a user.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in computer network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to computer network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of computer network 100 in greater detail, according to various embodiments. As shown, network backbone 130 may provide connectivity between devices located in different geographical areas and/or different types of local networks. For example, computer network 100 may comprise branch/local networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, computer network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in computer network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of computer network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the computer network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a routing insight process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various embodiments, as detailed further below, routing insight process 248 may also include computer executable instructions that, when executed by processor(s) 220, cause device 200 to perform the techniques described herein. To do so, in some embodiments, routing insight process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, routing insight process 248 may employ one or more supervised, unsupervised, or semi-supervised machine learning models. Generally, supervised learning entails the use of a training set of data, as noted above, that is used to train the model to apply labels to the input data. For example, the training data may include sample telemetry and/or path performance data that has been labeled as being indicative of a path performance level. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that routing insight process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

In further embodiments, routing insight process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, process 248 may use a generative model to generate synthetic network traffic based on existing user traffic to test how the network reacts. Example generative approaches can include, but are not limited to, generative adversarial networks (GANs), large language models (LLMs), other transformer models, and the like.

FIG. 3 illustrates an example 300 of an edge router 308 accessing a cloud-hosted application or service 306. As shown, assume that there are n-number of endpoints 302 at a particular location for which edge router 308 provides external connectivity. An online application or service provider may maintain any number of points-of-presence (PoPs), such as PoPs 304, to which edge router 308 may connect. Accordingly, edge router 310 may access a cloud-hosted application or service 306, such as a SaaS application, via a first PoP among PoPs 304, a second PoP among PoPs 304, etc.

However, the network performance when accessing the cloud-hosted application or service 306 via PoPs 304 is not guaranteed. Indeed, ensuring that traffic SLAs are met may require adjustments:
To meet SLAs, exceptions might be required for traffic that should not be sent through the gateway but directly sent via Direct Internet Access (DIA) locally, in case the gateway is not able to provide a good enough performance for a specific kind of traffic, which highly depends on Peering between the Online application or service provider Gateway POP and SaaS provider or intermediate Autonomous Systems (AS). For instance, it is sometimes recommended to send out VoIP traffic directly DIA to achieve better performance. However, this defeats the purpose of delivering WAN and security directly in the cloud while relying only on a very simple unique tunnel from all locations.
Selection of the “closest POP” is usually based on either geo-location, AnyCast (e.g., for secure web gateways relying on HTTPS proxies), probing results (e.g., selecting the POP with the lowest latency), or by fixing a static PoP location (e.g., as is usually done when setting up fixed IPsec tunnels). However, online application or service providers tend to have rather dense sets of PoPs to which a location can connect. Thus, the closest PoP is not always the best one to use, in terms of providing the best possible application experience. In particular, a POP might be struggling at certain times of the day to satisfy the SLA of the application traffic, while other nearby PoPs might not.
The performance of a given POP can also vary between applications. Indeed, performance can be influenced by any or all of the following factors:
   Edge to PoP.
   POP load.
   POP to POP, if traffic is sent through a backbone.
   POP to SaaS. Different PoPs might have different types of inter-connect or peering with SaaS services and might end up going to different SaaS physical endpoints, even if the SaaS exposes a single logical endpoint.

As discussed with respect to illustrative FIG. 4 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users' (e.g., employees') devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable implementation of categorical classification.

FIG. 4 is a block diagram of an example observability intelligence platform 400 that can implement one or more aspects of the techniques herein (e.g., through execution of routing insight process 248). The observability intelligence platform is a system that monitors and collects metrics of performance data for a network and/or application environment being monitored. At the simplest structure, the observability intelligence platform includes agents 410 (e.g., one or more agents) and one or more servers and/or controllers, such as the controller 420. Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller 420 (or controllers) as directed. Note that while FIG. 4 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents 410 may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page, i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 420 is the central processing and administration server for the observability intelligence platform. The controller 420 may serve a browser-based user interface (UI), which may be referred to as an interface 430 that is the primary interface for monitoring, analyzing, and troubleshooting the monitored environment. Specifically, the controller 420 can receive data from agents 410 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 430. The interface 430 may be viewed as a web-based interface viewable by a client device 440. In some implementations, a client device 440 can directly communicate with controller 420 to view an interface for monitoring data. The controller 420 can include a visualization system 450 for displaying the reports and dashboards related to the disclosed technology. In some implementations, the visualization system 450 can be implemented in a separate machine (e.g., a server) different from the one hosting the controller 420.

Notably, in an illustrative Software as a Service (SaaS) implementation, an instance of controller 420 may be hosted remotely by a provider of the observability intelligence platform 400. In an illustrative on-premises (On-Prem) implementation, an instance of controller 420 may be installed locally and self-administered.

The controllers 420 receive data from different agents, such as the agents 410 (e.g., Agents 1-4) deployed to monitor networks, applications, databases and database servers, servers, and end user clients for the monitored environment. Any of the agents 410 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be embodied as small files using web-based technologies, such as JavaScript agents injected into each instrumented web page (e.g., as close to the top as possible) as the web page is served and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

In accordance with certain implementations, both self-learned baselines and configurable thresholds may be used to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (e.g., an application instance) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the extensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

As noted above, continually analyzing and deriving insights about the routing of traffic and a variety of path characteristics on Internet is a very complex task because of several factors, such as:
Scale: the high number of devices and networks connected to the Internet.
Dynamism: traffic and routing decisions are not static.
Multiple paths: there are usually multiple valid paths between any two points on the Internet.
Decentralization: the Internet is a decentralized network with no central governing system and, therefore, there is not a central place where current global routing can be queried.
Lack of visibility: most if not all of the network operators control how traffic traverses their network and do not provide any means of visibility into the routing decisions taken. In addition, many times, traffic policies in the networks also prevent measurement probes from traversing the network.

For these reasons, traditional path probing mechanisms are unable to capture insights in real-time such as:
which nodes are the most important ones from a global routing point of view,
significant changes in the routing patterns,
etc.

However, large-scale agent deployments, such as that of ThousandEyes by Cisco Systems, Inc., are able to compile large datasets of information regarding the Internet, such as via path trace tests, ping tests, application session tests and more. This presents new opportunities to extract insights regarding the Internet in real-time.

——Extracting Insights from Real-Time Internet Routing Data——

The techniques introduced herein dynamically generate insights from path trace data, to provide information about the routing of traffic on Internet at different levels of granularity. Providing visibility into routing pattern changes across the Internet goes beyond simply observing network dynamics, as significant variations of network paths may affect applications that would otherwise require a consistent experience. Achieving visibility over these behaviors can help during the planning and delivery of application services, as well.

Illustratively, the techniques described herein may be performed by hardware, software, and/or firmware, such as in accordance with routing insight process 248, which may include computer executable instructions executed by the processor 220 (or independent processor of interfaces 210) to perform functions relating to the techniques described herein.

Specifically, according to various embodiments, a device generates a routing graph using path trace data, wherein nodes of the routing graph represent different entities in one or more computer networks. The device computes importance metrics for the nodes in the routing graph based on their traffic loads. The device generates an insight regarding the one or more computer networks based on the importance metrics for the nodes. The device provides the insight to a user interface for presentation to a user.

Operationally, FIG. 5 illustrates an example architecture 500 for extracting insights from real-time Internet routing data, in various implementations. As shown, routing insight process 248 may include any or all of the following components: a global graph generator 502, a data summarization module 504, an insight generation module 506, a data visualization module 508, and/or a traffic experience enhancer 510. As would be appreciated, the functionalities of these components may be combined or omitted. In addition, these components may be executed in a device or in a distributed manner, in which case the combination of executing devices can be viewed as their own singular device for purposes of executing routing insight process 248.

In various implementations, global graph generator 502 may process telemetry data 512 collected by any number of agents distributed throughout the Internet (e.g., agents 410 in FIG. 4). For instance, telemetry data 512 may include path trace data collected by the agents by sending probes along different paths within the Internet to identify the intermediate hops between different sources and destinations. Further information that telemetry data 512 may include may also take the form of path metrics (e.g., delay, loss, jitter, etc.), application-specific metrics, or the like.

Based on telemetry data 512, global graph generator 502 may formulate the connectivity graph between any pairs of points in the Internet. From these, global graph generator 502 may generate any number of routing graphs, depending on the slicing level used. Such slicing may correspond to the entities that nodes in the routing graph represent. For instance, nodes in a routing graph may represent different autonomous systems, PoPs, or the like. In the case of PoPs, the nodes may be tied to different geographic areas, such as cities, countries, other regions, etc. Preferably, global graph generator 502 may construct its global routing graph(s) in real-time, as well as performing analytics on millions of hops to determine various performance metrics.

In one implementation, global graph generator 502 may process telemetry data 512 in batches of predefined size and restrict its resulting graphs to include links observed only inside the batch. In another implementation, global graph generator 502 may process telemetry data 512 sequentially, adding the links that are observed to a routing graph as needed and removing links that have not been observed for more than a certain amount of time.

Data summarization module 504 may take as input the graph(s) generated by global graph generator 502 and apply a summarization model to the nodes of the graph, to extract a summary of the graph. For instance, such a summarization model may take the form of a machine learning model, a page rank algorithm, the Hyperlink-Induced Topic Search (HITS) algorithm, algorithms based on graph neural networks, or the like. In general, the summarization may take the form of importance metrics for each of the nodes in the graph under analysis that indicate the traffic load of the entity associated with that node.

In one implementation, data summarization module 504 may perform the summarization at predefined times. In another implementation, data summarization module 504 may perform the summarization only after an update of a graph by global graph generator 502. In yet another implementation, data summarization module 504 may perform the summarization on demand, such as in response to a request from a user interface 514.

Insight generation module 506 may then analyze the outputs of data summarization module 504 to generate insights for the user of user interface 514. More specifically, insight generation module 506 may be responsible for tracking the output metrics of data summarization module 504 over time and extracting insights based on this tracking. For instance, if data summarization module 504 ranks the nodes of the network using the page rank algorithm, insight generation module 506 may detect events involving a significant change (e.g., above a given threshold) on the ranks of a significant number of nodes, which can indicate a major rerouting event on the Internet. Another example of an insight can be a sudden drop in the ranking of a single node, which can indicate an outage involving the network entity represented by the node.

In addition to these insights, insight generation module 506 may also compute, for all source and destination pairs, the change of importance of intermediate autonomous system networks and/or POPs, where the importance is defined based on the number of flows leaving and entering a given a or POP. In essence, the importance metrics may measure the path churn over time.

In one implementation, insight generation module 506 may compute insights from a predefined set of metrics and variations. In another implementation, the user of user interface 514 may specify the metrics to track and/or specific variations to monitor. In yet another implementation, user interface 514 may obtain its configuration from a policy manager.

Data visualization module 508 during execution may be responsible for presenting any or all of the outputs of global graph generator 502, data summarization module 504, and/or insight generation module 506 to user interface 514 for review by a user. To this end, data visualization module 508 may generate plots, charts, text, images, or other indicia, to convey the information that these components extracted from telemetry data 512.

By way of example, FIG. 6 illustrates an example plot 600 of importance metrics for different autonomous systems over time. In some cases, data visualization module 508 may generate plot 600 or a similar plot, which shows the importance metrics for different autonomous systems over time. Here, the importance metrics take the form of page ranks representing the relative traffic loads observed across each of the autonomous systems. In turn, one insight that data visualization module 508 may provide is that the importance metrics for the listed autonomous systems (i.e., Amazon, TeliaNet, Microsoft, KDDI, and Cloudflare) are relatively stable over the timespan shown.

In contrast, FIG. 7 illustrates an example plot 700 showing unstable importance metrics for different autonomous systems over time. Similar to FIG. 6, data visualization module 508 may generate plot 700 or a similar plot, to convey the importance metrics for different autonomous systems over time to a user. Unlike in FIG. 6, though, many of the autonomous systems shown in plot 700 (e.g., Comcast Cable, Webex, Cogent, Akamai, and NTT America) exhibit wide oscillations in their importance metrics over the time period shown. For instance, Comcast Cable is typically very important with a high page rank at certain times (e.g., second or third), with its importance suddenly dropping at other times below thirtieth place. In such a case, data visualization module 508 may provide the insight to user interface 514 that significant rerouting events have occurred in the Internet during these other times.

FIG. 8 illustrates an example plot 800 of importance metrics for different PoPs over time. Here, the different PoPs may be within the same network and associated with different cities, such as Columbus in the U.S. (US), Tokyo in Japan (JP), Dublin in Ireland (IE), Denver in the U.S. (US), and Frankfurt in Germany (DE). As can be seen, these PoPs exhibit stable importance metrics over the time period shown. In such a case, one insight that data visualization module 508 may provide is that these PoPs appear relatively stable over time.

Referring again to FIG. 5, traffic experience enhancer 510 may be configured to generate recommendations based on the computed insights and path churns/importance metrics, which could be useful for application delivery planning. To do so, traffic experience enhancer 510 may interact with the user via user interface 514, taking as input the requirements of a particular application (e.g., in terms of throughput, latency, loss, jitter, etc.) and including the geolocation of both the users and the potential application hosting sites.

For instance, traffic experience enhancer 510 may leverage telemetry data 512 to evaluate and recommend the most effective combinations of ISPs and hosting providers, providing the most consistent application experience. In the case of FIG. 8, for instance, assume that there is a client located in Ohio. Based on the PoPs shown in plot 800 exhibiting stable importance metrics, traffic experience enhancer 510 may make a recommendation via user interface 514 that the application traffic should be routed through the POP in Columbus, since its importance metrics appear stable.

As would be appreciated, routing insight process 248 may continuously update the outputs of its components based on the collection of telemetry data 512 over time. For instance, as noted, global graph generator 502 may update its graphs in response to entities appearing or disappearing from the path trace information in telemetry data 512. In such a case, data summarization module 504 may determine that the importance of a particular PoP has suddenly dropped from being relatively high to being non-existent, leading to insight generation module 506 extracting the insight that the POP may be down, and traffic experience enhancer 510 generating the recommendation that traffic for a particular application be routed via a different, more stable POP, instead.

FIG. 9 illustrates an example of a simplified procedure 900 (e.g., a method) for extracting insights from real-time Internet routing data, in accordance with one or more embodiments described herein. For example, a non-generic, specifically configured device (e.g., device 200) may perform procedure 900 by executing stored instructions (e.g., routing insight process 248). The procedure 900 may start at step 905, and continues to step 910, where, as described in greater detail above, the device may generate a routing graph using path trace data, whereby nodes of the routing graph represent different entities in one or more computer networks. For instance, the device may obtain the path trace data from a plurality of probing agents distributed throughout the one or more computer networks. In some implementations, the different entities are autonomous systems. In further implementations, the different entities are points-of-presence (PoPs) located in different geographical areas. In some implementations, the device may also update the routing graph over time based on additional path trace data collected over time from the one or more computer networks. For instance, the device may update the routing graph over time by removing a particular node in the routing graph representing an entity that is not indicated in the additional path trace data.

At step 915, as detailed above, the device may compute importance metrics for the nodes in the routing graph based on their traffic loads. In various implementations, the device computes the importance metrics for the nodes using a summarization model. For instance, the device may use a machine learning model or page rank algorithm to determine the importance of the entities based in part on the path trace data.

At step 920, the device may generate an insight regarding the one or more computer networks based on the importance metrics for the nodes, as described in greater detail above. In some instances, the insight indicates a rerouting event in the one or more computer networks based on a change in the importance metrics for a plurality of the nodes. In further cases, the insight indicates an outage associated with a particular one of the different entities based on a decrease in its associated importance metric.

At step 925, as detailed above, the device may provide the insight to a user interface for presentation to a user. In various implementations, the device may also provide, based in part on the insight, a recommendation indicative of an optimal routing path for traffic of a particular application.

Procedure 900 then ends at step 930.

It should be noted that while certain steps within procedure 900 may be optional as described above, the steps shown in FIG. 9 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments for extracting insights from real-time Internet routing data, it is to be understood that various other adaptations and modifications may be made within the spirit and scope of the embodiments herein. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
generating, by a device, a routing graph using path trace data, wherein nodes of the routing graph represent different entities in one or more computer networks;
computing, by the device, importance metrics for the nodes in the routing graph based on their traffic loads;
generating, by the device, an insight regarding the one or more computer networks based on the importance metrics for the nodes; and
providing, by the device, the insight to a user interface for presentation to a user.

2. The method as in claim 1, wherein the insight indicates a rerouting event in the one or more computer networks based on a change in the importance metrics for a plurality of the nodes.

3. The method as in claim 1, wherein the insight indicates an outage associated with a particular one of the different entities based on a decrease in its associated importance metric.

4. The method as in claim 1, wherein the device computes the importance metrics for the nodes using a summarization model.

5. The method as in claim 1, further comprising:
providing, by the device and based in part on the insight, a recommendation indicative of an optimal routing path for traffic of a particular application.

6. The method as in claim 1, wherein the different entities are autonomous systems.

7. The method as in claim 1, wherein the different entities are points-of-presence (PoPs) located in different geographical areas.

8. The method as in claim 1, further comprising:
updating the routing graph over time based on additional path trace data collected over time from the one or more computer networks.

9. The method as in claim 8, wherein the device updates the routing graph over time by removing a particular node in the routing graph representing an entity that is not indicated in the additional path trace data.

10. The method as in claim 1, further comprising:
obtaining, by the device, the path trace data from a plurality of probing agents distributed throughout the one or more computer networks.

11. An apparatus, comprising:
one or more network interfaces;
a processor coupled to the one or more network interfaces and configured to execute one or more processes; and
a memory configured to store a process that is executable by the processor, the process when executed configured to:
generate a routing graph using path trace data, wherein nodes of the routing graph represent different entities in one or more computer networks;
compute importance metrics for the nodes in the routing graph based on their traffic loads;
generate an insight regarding the one or more computer networks based on the importance metrics for the nodes; and
provide the insight to a user interface for presentation to a user.

12. The apparatus as in claim 11, wherein the insight indicates a rerouting event in the one or more computer networks based on a change in the importance metrics for a plurality of the nodes.

13. The apparatus as in claim 11, wherein the insight indicates an outage associated with a particular one of the different entities based on a decrease in its associated importance metric.

14. The apparatus as in claim 11, wherein the apparatus computes the importance metrics for the nodes using a summarization model.

15. The apparatus as in claim 11, wherein the process when executed is further configured to:
provide, based in part on the insight, a recommendation indicative of an optimal routing path for traffic of a particular application.

16. The apparatus as in claim 11, wherein the different entities are autonomous systems.

17. The apparatus as in claim 11, wherein the different entities are points-of-presence (PoPs) located in different geographical areas.

18. The apparatus as in claim 11, wherein the process when executed is further configured to:
update the routing graph over time based on additional path trace data collected over time from the one or more computer networks.

19. The apparatus as in claim 18, wherein the apparatus updates the routing graph over time by removing a particular node in the routing graph representing an entity that is not indicated in the additional path trace data.

20. A tangible, non-transitory, computer-readable medium storing program instructions that cause a device to execute a process comprising:
generating, by a device, a routing graph using path trace data, wherein nodes of the routing graph represent different entities in one or more computer networks;
computing, by the device, importance metrics for the nodes in the routing graph based on their traffic loads;
generating, by the device, an insight regarding the one or more computer networks based on the importance metrics for the nodes; and
providing, by the device, the insight to a user interface for presentation to a user.
